(19) United States
(12) Patent Application Publication
(10) Pub. No.: US 2004/0244596 A1
(43) Pub. Date: Dec. 9, 2004

(54) Cookie dipper

(76) Inventor: Barry Lynn Ogline, Somerset, PA (US)

Correspondence Address: BARRY L. OGLINE, 818 OVERLOOK DRIVE, SOMERSET, PA, 15501, US

(21) Appl. No.: 10/452,011

(22) Filed: Jun. 3, 2003

(51) Int. Cl. A23L 1/00

(52) U.S. Cl. 99/275

(57) ABSTRACT

The ‘Cookie Dipper’ is a hand held utensil which may be used by adults or juveniles, to insert onto or into a creme filled cookie followed by, dipping the cookie into a beverage of their choice such as milk, coffee or other beverage. While using the ‘Cookie Dipper’ the user reduces the likihood of having their hands or fingers come into contact with the beverage they are dipping the cookie into.

‘Cookie Dipper’ is intended to be used by adults or juveniles. Its purpose is to insert the tines of the ‘Cookie Dipper’ into the middle of the cream filled cookie then used to dip the cookie, while it is inserted on the Cookie Dipper, into milk, coffee or other beverages preferred by the user.

### FIGURE DESCRIPTION

[See Enclosed Document for Drawings]

FIG. 1 A view of the ‘Cookie Dipper’ as it is lying on a flat surface.

FIG. 2 An angled semi-side view of the ‘Cookie Dipper’.

FIG. 3 A side view of the ‘Cookie Dipper’.

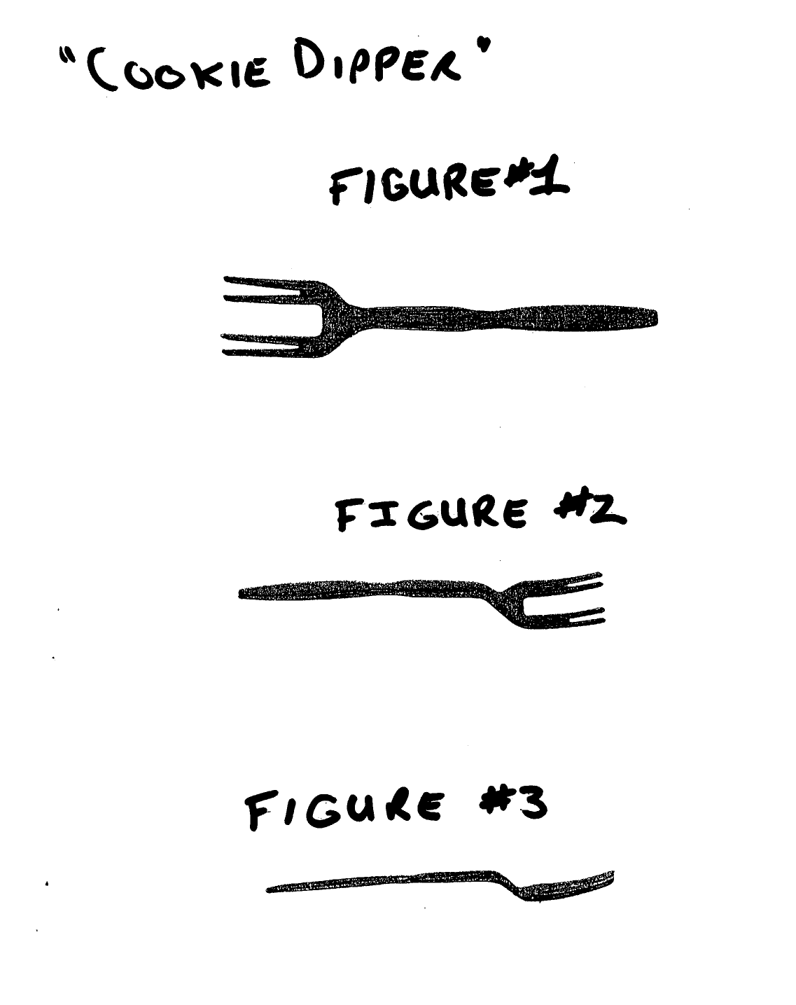

The measurement specifications of the Cookie Dipper are as follows:

1. The entire length of the COOKIE DIPPER from the end of the tines to the end of the handle is 7½ inches.

2. The HEAD is 1⅜ inches wide; is 1/16 inch thick and from the end of the tines to the neck of the handle is 2 inches long.

3. When the Cookie Dipper is lying flat on a solid surface, the head and tines are curved slightly upwards with the tines resting ¼ inch above the solid surface at their highest point.

4. Each TINE has rounded tips, are 1½ inches long from the head to the tip of each tine; are 1/16 inch thick; are 1/16 inch wide at the end of the Cookie Dipper and are 3/16 inch wide where the tines mold into the head.

5. The space between each set of tines is ¼ inch at the end of the Cookie Dipper and 1/16 inch where the tines mold into the head.

6. The space between the two tines on the left and the two tines on the right known as the CANAL which is ⅝ inch wide.

7. Between the head and the handle is the NECK of the Cookie Dipper which is ¾ inches wide closest to the head; is ⅜ inches wide where it molds into the handle and is ⅛ inch thick.

8. The NECK is curved so that when the Cookie Dipper is lying flat on a solid surface, it can do so without falling over with ½ inch between the underside of the neck to the solid surface at its highest point with a curve toward the head which rests on the solid surface.

9. The HANDLE is ⅛ inch thick with a slight upward curve from it's end to the neck; is 5 inches in length from the end of the Cookie Dipper to the neck; ½ inch wide closest to the grasper; ⅜ inches wide at the neck and is⅜ inches wide at the end of the handle which is a straight lined, smooth rounded edge which is ¼ inches wide at the very tip.

10. The middle of the handle is known as the GRASPER, which is located 2½ inches from the end of the handle; 2 inches from the neck; is ½ inch in length of the handle; is ¼ inch wide at its narrowest point in the middle which also contains a slight dip and is 7/16 inches wide on either side toward both the neck as well as, to the end of the handle.

11. The BACK of the Cookie Dipper HANDLE has a curved indentation from the NECK to the GRASPER and from the end of the HANDLE to the GRASPER is a curved indentation.

12. The back of the Cookie Dipper HEAD is a smooth finish.

1. The design for the cookie dipper is such that the user, a juvenile or an adult is enabled the opportunity to insert a cream filled cookie onto the cookie dipper followed by, dipping the cookie which has been inserted onto the cookie dipper into milk, coffee or other beverages of choice which prevents excessive liquid from coming into contact with the users fingers and hands.
The design of the Cookie Dipper head is in the shape similar to that of a spoon and fork combination, slightly curved, with a total of four tines, two on either side of the head that are used to grasp/penetrate the cookie and hold it in place. The wider space between the four tines, referred to as the canal, allows for the cookie to remain in place but, so as not to disturb the entire formation of the cookie or the cream of the cookie. The handle has an indentation on both sides, which is referred to as the grasper. The grasper permits the user to have a better grip on the Cookie Dipper thus, reducing the likelihood of the Cookie Dipper slipping out of the users' hand. The face of the handle, from the end of the handle to the head, has a shallow smooth dip that allows the users fingers to rest while holding the Cookie Dipper. The portion of the handle closest to the head is referred to as the neck. The reverse side of the Cookie Dipper is referred to as the back.
